(19) United States
(12) Patent Application Publication
(10) Pub. No.: US 2017/0322930 A1
(43) Pub. Date: Nov. 9, 2017

(54) DOCUMENT BASED QUERY AND INFORMATION RETRIEVAL SYSTEMS AND METHODS

(71) Applicant: Jacob Michael Drew, Dallas, TX (US)

(72) Inventor: Jacob Michael Drew, Dallas, TX (US)

(21) Appl. No.: 15/597,993

(22) Filed: May 17, 2017

Related U.S. Application Data
(60) Provisional application No. 62/333,159, filed on May 7, 2016.

(51) Int. Cl. G06F 17/30

(52) U.S. Cl. CPC G06F 17/30011; G06F 17/30864; G06F 17/3033; G06F 17/3053

(57) ABSTRACT

Disclosed herein are systems and methods for document based query and information retrieval which rapidly locate similar documents within a document corpora providing a document based search result to the search initiator including one or more estimated measures of similarity for each search result item and appropriate search result document metadata. After providing document based similarity approximation search results, the system also rapidly retrieves and determines more accurate measures of similarity, including the relevant document terms and term statistics used to determine an exact measure of similarity, between the document based query document term collection and individual search result document term collections using one or more computing devices, that are application and platform independent, participating in a distributed multicore processing environment. One or more web clients transmit document based query and information retrieval requests to one or more restful services which provide the document based search results to the search initiator via stateless HTTP responses and requests. Dimensionality reduction techniques are used to limit the total number of similarity approximations and document term data similarity calculations performed during both nearest neighbor pre-processing and document based searches. The systems and methods disclosed include document based query and information retrieval embodiments providing document search results to the search initiator which include the details supporting exactly how two documents are, in fact, similar using a given particular document based query and a specific measure for document based similarity.

### PRIORITY CLAIM

This disclosure claims priority to U.S. Provisional Patent Application Ser. No. 62/333,159, the entirety of which is hereby incorporated by reference for all purposes.

### TECHNICAL FIELD

The present invention relates in general to the field of document based query and information retrieval, and more particularly to rapid document similarity detection using an entire document or specific parts of a document as the content of a document-document similarity or nearest neighbor search.

### BACKGROUND

Common internet-based search and information retrieval typically involves a query-document based search in which the search initiator enters a particular word, set of words, or a given phrase (the search query) into a search engine. In this scenario, the user has a pre-determined and specific “search query” which is expected to result in a given set of documents, web pages, or digital content (the search result), provided by the search engine, which most closely embodies the highest semantic similarity or relevance to the search query itself.

When the search result is returned, the search initiator may only review the results to determine, if they contain the desired content. Unfortunately, the document fingerprints or “sketches” used by current internet-based search and information retrieval systems to rapidly locate each piece of content provided within the search result do not allow search initiators to see specifically why or how each piece of content provided within the search result was determined to be a relevant match. When the search initiator's search query contains very few words, a manual review of the search result's content may be possible. However, as the length of the search initiator's search query increases, the complexity of a manual review grows exponentially.

In certain use cases, a search initiator may require a search query which is represented by an entire document. This is referred to as document based query and information retrieval using a document-document based measure of similarity rather than the query-document based similarity measures used by common search engines. Modern search engines are limited in this regard. For example the current Google default for “Number of query terms allowed in search requests” is 50 terms. Many common document types would quickly exceed 50 total terms. Furthermore, it would be nearly impossible for the search initiator to decipher how or why each document was selected within a particular result set by performing their own manual review of the result set contents. In addition, manual reviews would be very time consuming and prone to error since the total number of search terms is likely very large.

Some systems disclose tools and techniques for document-document based similarity measures. However, current solutions do not provide the functionality to rapidly search for a known document within a very large document corpora such as the collection of patents and patent applications maintained by the USPTO. Furthermore, document-document based comparison systems are limited by the similarity metric deployed to compare multiple documents, and the speed at which document based query and information retrieval may occur. These limitations often result in extensive and sometimes very overhead intensive document based search processing. Furthermore, these rigid systems typically do not support the ability to rapidly inform the search initiator specifically why and how any given search result content compares and is relevant to the search initiator's document based query.

### SUMMARY

In accordance with one aspect of the present invention, a Document Based Query and Information Retrieval System and Method are provided which substantially eliminates or reduces disadvantages associated with previous systems.

According to one embodiment, a Document Based Query and information Retrieval System and Method are provided for rapid document based searches and information retrieval given a very large corpora of known documents such as the collection of patents and patent applications maintained by the USPTO. The search initiator using such a system provides as “the search query” a known document key which references an entire document that is used for the purposes of the document based query. For example, a US patent or patent number might be used as a known document key in this particular embodiment.

In certain implementations, documents might be further divided into a plurality of document sections which are made available to the search initiator for use as the document in the document based query. In such embodiments, document keys may be accompanied with document sub-keys referencing a particular segment, chapter, or section of a document. For instance, a Document Based Query and Information Retrieval System embodiment supporting the USPTO patent and patent application corpora may provide document based queries using only the patent text, patent claims, or all text content included within a particular patent document. In some such embodiments, the US patent number may be provided by the search initiator as the system's required document key.

Since the present invention supports providing the search initiator both document content and similarity based content for search results, many embodiments will include one or more document processing system instances which perform a substantial amount of document pre-processing. In one such system processing patent applications provided by the USPTO Bulk Data System, bulk data files are downloaded which include numerous US patent applications in a single “zipped” or compressed file format. First, these files are decompressed exposing the raw XML data which contains the metadata and text content for many thousands of individual patent documents. A document processing system instance performs content extraction targeting both the required metadata and text content for each individual patent document.

One or more document processing system instances may execute in parallel to process large volumes of documents. In one embodiment, document processing system instances may each process a separate compressed zip file downloaded from the USPTO Bulk Data System. In another embodiment, a single bulk download file could be divided into multiple segments each processed by a plurality of document processing system instances. Yet in another embodiment, a plurality of document processing system instances may be managed by a master program which receives a stream of documents passing each individual document to the document processing system CC with the least amount of documents in its processing queue.

In some embodiments, document metadata is placed directly into a document metadata repository which can be used to further filter document based search results. For example, certain embodiments collecting patent metadata might filter document based search and information retrieval results using patent application filing dates, priority dates, legal status, inventor names, assignee names, or any other number of metadata elements available for a particular patent document. Certain systems may also retrieve document related content during document processing from the input data provided or any other source available to retrieve document related content. For example, one invention embodiment might use a 3rd party service to download pdf formatted patent documents for each patent added to the metadata repository placing each pdf document into the proper document content repository folder for a given patent document during document processing.

In one such example embodiment, HTML formatted patent text and claims are extracted from the raw XML data contained in a USPTO bulk data file. Next, one or more “headless” browser instances are executed in-memory to render the HTML formatted patent text. The patent specific HTML is saved to a file in the document content repository, and a headless browser instance is directed to render the file using a file:// URL. Once the browser renders the HTML, the displayed patent text is then saved for further downstream document pre-processing.

In some embodiments, patent specific HTML may be divided into sections or even separate files, such as patent text and patent claims specific text files. Yet in other embodiments, patent specific HTML may be passed in memory directly to the headless browser using no file, and only the displayed browser text is saved. While a preferred embodiment may use browser rendering to remove HTML tags and HTML specific entity definitions such as: (&amp, &lt, &gt etc.) from patent specific HTML, other embodiments may simply use regular expressions, lookup tables, html processing packages such as HTML agility pack or any combination of the aforementioned tools to process and convert HTML specific input data to text. Yet other embodiments may receive text documents as input data and require no HTML specific input data processing at all to extract the document's text.

Many invention embodiments will include one or more Term Repositories. The term repository may contain document specific terms, term frequencies, and any other term specific values relevant to the production of similarity based content for search results within one or more term data collections. Typically during document processing, document specific text is processed using any number of tokenization and term extraction techniques to generate document specific terms. For example, different embodiments may use term extraction techniques including (but not limited to) natural language processing (NLP), paragraph detection, sentence detection, tokenization of individual words within sentences, part of speech tagging, noun phrase detection, phrase detection, n-gram production using individual word tokens, or k-mers production using text character chunks of any length. In such embodiments, values produced using any of these techniques may be referred to as document specific “terms” within the context of this invention and stored within one or more term data collections residing in one or more terms repositories. In addition, multiple term values may be produced using any number of term production techniques for a single document in some embodiments.

Document specific terms may also be partitioned in any number of ways or separated into multiple document specific term data files or collections located within a term repository. For example, one embodiment storing patent specific terms might produce two separate files or outputs (one for patent text and one for patent claims specific text) including each of the following term types: paragraphs, sentences, noun phrases, unique words, two word n-grams, three word n-grams, and four word n-grams. Yet in another embodiment, only sentence terms for each document may be saved in a terms repository. In some embodiments, document terms could be partitioned by term types in separate term collections, files, or database entries.

As document specific terms are extracted and added to the term repository, certain embodiments may also collect and update any number of statistics about each unique tell within the term data collections or term stats repository. In one example embodiment, term document frequency statistics are collected for each unique term encountered within the system. For example, as each unique term is extracted from a given document, the term document frequency is incremented one time per document, per unique term. The term document frequency explains how many documents each unique term occurs in. Also, some embodiments include a “total number of documents” statistic which is incremented one time for each new document processed.

Once all documents are processed, a final post-processing step may update each term file or collection adding statistics which require knowledge of the entire document corpora. For example, certain embodiments may add the inverse document frequency (IDF) to each document specific term within a term file or collection. This pre-calculated statistic is very valuable for rapid document similarity comparisons within a document corpora, but may not be present in all invention embodiments. Any number of statistics may be added to each individual term within one or more term files during the post-processing step. In addition, a term file or collection may include special reserved terms which do not appear in any document's text.

In one example embodiment, the special reserved term “***TermsTotalFrequency” might include a value entry that reflects the sum of all terms frequencies in a given document or document section while the special reserved term “***UniqueTerms” might contain the number of unique terms within a given document or document section. Any number of special reserved terms may be used within individual term collections to track such statistics related to a term collection.

Many invention embodiments will include one or more document similarity pre-processing system instances which perform a substantial amount of document similarity pre-processing. All pre-processing steps are intended to facilitate rapid document based query and information retrieval requests supported by a particular system embodiment. The document similarity pre-processing system may include one or more similarity engines with at least one or more similarity functions.

In one example embodiment, a similarity engine may include a Jaccard similarity function which only requires two sets of unique document terms as input. The similarity function

$$Jaccard ( A , B ) = \frac{\vert A ⋂ B \vert}{\vert A ⋃ B \vert}$$

determines two document's similarity by dividing the intersection count of document A and document B terms by the union count of document A and B terms which produces a percentage measure of similarity between 0 and 1.

In another embodiment, a weighted Jaccard similarity function incorporates document term frequency for another measure of similarity between documents with no change required to the term data collection or document processing previously described.

$$WeightJaccard ( A , B ) = \frac{\sum i min ( {A}_{i} , {B}_{i} )}{\sum i max ( {A}_{i} , {B}_{i} )} ,$$

where the summation of the intersected term's minimum frequency values are divided by the summation of the union term's maximum frequency values.

In other embodiments where each document term's frequency and IDF values are stored within the term data collection, other similarity metrics such as Cosine similarity using TF-IDF (term frequency-inverse document frequency), IDF similarity, or TF-IDF similarity or Weighted TF-IDF similarity using a jaccard or Weighted Jaccard style formula where the counts or frequencies for Aᵢ, Bᵢ are replaced with TF-IDF values are also possible.

In a more simplistic embodiment, only term repository data and statistics are used to perform document nearest neighbor identification during document similarity pre-processing. One or more term similarity matrices are generated by comparing each document's term data collection to all other documents using a given similarity function within the similarity engine. The resulting output is a pairwise orthogonal similarity or distance matrix where each row-column intersection represents the similarity or distance between two particular documents within the corpora. However, such a matrix in a patent document corpora embodiment may be far too large since there could be over 9.2 million*9.2 million patent document entries, if all patents documents were supported. In addition, this data structure is not conducive to rapid similar document based searches in a document based query and information retrieval system.

In order to avoid the aforementioned challenges in many embodiments, the document neighbors repository contains a document key entry for each known document within the system which includes the top n most similar document references collection as the value for each entry. For example, a patent corpora with 9.2 million patent documents may contain a document neighbors repository including 9.2 million entries with 100, 1000, 10000 or even 9.2 million most similar neighbor document references as a value. Such embodiments may also include a calculated similarity value along with each similar document reference. Yet other embodiments may simply sort the references based on similarity while not actually retaining the similarity value itself.

Certain embodiments may use more than one similarity function or a single similarity function calculated on multiple sub-sections of text within a document in a similarity score ensemble to generate a collection of one or more similarity scores between two document term collections. For example, an embodiment using the patent corpora might create a blended similarity score ensemble using two individual similarity scores from both the patent text and patent claims while other embodiments may maintain three separate similarity scores for each similar document reference.

More complex embodiments containing larger numbers of known documents may include a document fingerprint system for generating document sketches. A document sketch is a highly compact representation of a document term data collection, typically a collection of integers, which may be used for rapid document similarity comparisons. In accordance with this aspect of the present invention, some embodiments may utilize various forms of minhashing, locality sensitive hashing, or other techniques to generate one or more levels document fingerprint sketches.

In one such embodiment, a collection or family of randomly seeded hashing functions are used to perform minhashing operations using the document term data as input. Each document term is passed through each of the randomly seeded hashing functions producing a hash value while only the minimum hash value produced by each of the hashing functions is maintained. The resulting minhash signature includes one minimum hash value for each random hashing function used after hashing each of the terms within a document's term data collection. The minhash signatures for two documents can be compared to accurately approximate the Jaccard similarity between the two documents. For example, 2 minhash signatures with a total of 25 matching minhash values out of a 100 value minhash signature would indicate that two documents are 25% similar.

Some embodiments may use longer minhash signatures which require more randomly seeded hashing functions and additional hashing operations to generate the longer minhash signature. In such embodiments, additional processing overhead is exchanged for more accurate Jaccard similarity approximations. The preferred embodiment balances minhash signature length with the appropriate amount of similarity approximation accuracy required for a particular system.

In certain document fingerprinting embodiments, minhash signatures may also be divided into multiple “similarity” bands in order to reduce the number of document comparisons required to locate documents with high similarity. In accordance with this aspect of the present invention, certain embodiments may include additional “banding” hash values within each document fingerprint. For example, a minhash signature with 100 values might be divided into 5 bands with 20 minhash values each. In this embodiment, a single hash code is generated using the 20 values within each band adding 5 additional “band” values to the original 100 value document sketch. When searching for document neighbors, only documents with >=n matching band values are selected as a “first cut” to perform further similarity comparisons against. In such an system, if only 5% of documents share the same >=n matching band values, the other 95% of remaining documents may be excluded from further similarity engine pre-processing when determining document neighbors.

Regardless of the document fingerprinting technique used, certain invention embodiments may utilize document fingerprints to drastically reduce the number of similarity engine pre-processing operations or total time required for similarity engine pre-processing execution. Certain embodiments may use document fingerprints during document neighbor identification to enhance neighbor candidates processing operations as previously described. In one such example embodiment, document fingerprint sketches are used to rapidly locate a document's nearest neighbors during similarity engine pre-processing operations. Each document within the document corpora is quickly compared to other documents with matching bands using the document sketches, and Jaccard similarity approximations are used to determine the top n most similar document references collection entries for each document within the document neighbors repository. Once approximations are completed, some invention embodiments may perform more comprehensive similarity pre-processing comparisons using some of all of the term data for all documents within the same similar document references collections. However, other embodiments may only calculate the true similarity score once a matching terms request has been made for two known documents.

Particular embodiments may use multiple processing instances of document processing, similarity pre-processing, and document fingerprinting systems. Likewise, other embodiments may deploy processing instances for each of these systems which operate in parallel using multiple worker threads which may execute on multiple processors. Furthermore, these systems could be implemented on a single pc, server, or multiple machines spread across multiple data centers in a cloud computing environment. Some invention embodiments may implemented as a web based application, while other embodiments may be installed as an application on a single computing device such as a mobile device, tablet, laptop, desktop, hardware implemented embedded system, or any combination of the aforementioned devices.

In one particular Web Based Document Query and Information Retrieval System embodiment, a document repository is implemented using one or more restful services exposing six primary operations between the web client applications and one or more restful service servers. Each of the primary operations are facilitated using HTTP requests and responses between a particular web client and the restful service application servers.

For example, a Web Based Document Query and Information Retrieval System embodiment servicing the USPTO patent corpora may include a known document neighbors operation which is made via the web client application providing a document key and possibly sub-keys via an HTTP request to the restful service. The known document neighbors request s facilitated by first accessing the document neighbors repository to retrieve the collection of top n most similar document references for the requested known document key provided. In certain embodiments, sufficient document metadata data may already be attached to the similar document references collection. However, in other embodiments, additional document metadata may be obtained from multiple locations including, but not limited to, the document metadata repository. Certain requests or embodiments may also require an optional document filtering step in which documents are removed from the top n most similar document references collection using document metadata or other filtering criteria. Finally, a document based search result HTTP response is provided back to the web client which includes sufficient similar document metadata for the document based query search results.

In some embodiments document based query search results may include very limited document metadata such as the document key, a US patent application number in some embodiments for example, the document title, author, inventor, assignee, and a brief selection of the document text. However, other embodiments may return a much more robust document based search result including estimated or actual document similarity scores, pre-fetched document term collections for some or all of the documents within a search result, and other document content such as a pdf or other files containing all or portions the document's text and or digital content.

According to one embodiment of the present invention, a known document terms request operation begins with a document key and possibly sub-keys provided via HTTP request to a Web Based Document Query and Information Retrieval System's one or more restful services. The operation accesses the appropriate term data repository to retrieve all the terms associated with the document key provided. Some embodiment's document terms request operation may comprise an additional optional filtering step to remove document terms which are irrelevant to the current operation. For example, certain embodiments which have attached IDF scores to each unique term in a document's term data collection may calculate each term's TF-IDF and remove terms which fall below a certain threshold. However, other embodiments may perform such work during document similarity pre-processing choosing to send the full term data collection's content during a known document terms request operation.

In one example embodiment supporting the USPTO patents corpora, a patent application number is provided to the restful service as the document key. In addition, the terms data repository may simply be one or more file servers containing a folder for each known document key. The terms data repository folder may contain any number of known term data collection related files using a standard file naming convention. The appropriate terms data repository file is accessed by the known document terms request operation which simply resolves the appropriate file path for the required terms data repository file such as: //US1234156/TermsRepository/3gramTerms.txt. The document terms request operation returns the appropriate terms data collection as an HTTP response to the web client application. Once the term data collection s retrieved, it could be further processed as part of a match request operation occurring on either the client or server side.

While the previously described file server arrangement serves as a basic system embodiment example, many other system configurations can be envisaged. Repository embodiments may be stored in databases, in-memory databases, file servers residing in memory on virtual ram-disk partitions, cloud enabled file servers or databases residing on network attached storage, direct attached storage, or storage area networks, and other in memory database solutions such as a NOSQL database or key-value pair data stores.

Particular invention embodiments may support a known document terms request and match operation. During this operation, at least two document keys are provided via HTTP request to a Web Based Document Query and information Retrieval System's one or more restful services. Next, the aforementioned known document terms request is performed for each of the known document's key and possibly sub-keys. Match term operations are then performed on the returned document terms collections to identify any matching terms between the two documents in question. In certain embodiments additional processing steps may occur during match term operations such as identification of all unique terms contained between two document terms collections. This may be considered a union operation between two term sets in certain system embodiments. Yet other implementations of the invention may include additional mathematical summations, division, multiplication, or log operations required by a particular similarity measure to determine the given similarity between the two document keys provided.

Some embodiments of the invention may include additional statistics or relevant data with the known document terms request and match operation results. For instance, a particular embodiment may utilize the resulting set of matched term data provided to calculate one or more measures of similarity between the two documents. In one example embodiment supporting the US patent corpora, matched patent terms resulting from a known document terms request and match operation are processed during the matched terms operations to calculate the Jaccard similarity between the two terms data collections. In another embodiment, terms data collection frequencies and inverse document frequencies are utilized during match term operations to calculate TFIDF weighted Cosine similarity between the two terms data collections. Yet in another embodiment, optional term filtering occurs to remove matched terms which are considered irrelevant to the current search for any number of reasons. Matched term requests, operations, and filtering steps could occur on the client or server side within the same or different invention embodiments.

According to one embodiment of the present invention, a Web Based Document Query and Information Retrieval System may comprise a known document content request in which a known document's key and possibly sub-keys are provided via HTTP request to one or more restful services requesting a particular piece of document content such as document text, images, metadata, or other document content digital presentation formats such as a pdf document.

In one embodiment, the appropriate document content repository file is accessed by the known document content request operation which simply resolves the appropriate file path for the required document data repository file such as: //US123456/ContentRepository/patent US123456.pdf. The document content request operation returns the appropriate document content as an HTTP response to the web client application. Once the document content is retrieved, it could be further subset or post-processed as part of a content processing operations occurring on either the client or server side, In one example embodiment, patent claims text retrieved from the content repository is tagged by a natural language processing engine to extract and provide all noun phrases contained within the claims text. Yet in another embodiment, a patent's pdf formatted document is modified to highlight a set of matching terms provided as input with the content request. In this embodiment, these terms may or may not have originated from the same patent included in the content request.

Unknown document based queries are also supported within certain invention embodiments. The Unknown Document Terms Request and Match operation receives a Match Terms Request including the submission of unknown document content. Similar to operations during Similarity Pre-processing, Document Fingerprint operations generate a sketch and optional band value assignments for the unknown document. Next, optional band filtering may occur to reduce the dimensionality of a nearest neighbor search by orders of magnitude. In an example embodiment supporting the US patent document corpora, bands may be used to eliminate a majority of patents from subsequent sketch and/or term data comparisons during similarity engine processing. For instance, an unknown patent application which shares a matching band value with only 5% of all known patent documents might eliminate 95% of sketch and/or term data comparison operations during similarity engine processing. However, other embodiments may envisage different forms of dimensionality reduction techniques to eliminate such operations within similarity engine processing.

Other embodiments, may choose to perform more comprehensive similarity engine processing operations searching a vast majority or even all of the known document sketches or term data collections. For instance, invention implementations which manage smaller document corpora's, have vast amounts of ample processing power, or require the most detailed similarity values may choose to eliminate document sketches altogether, opting to perform term data collection similarity comparisons between all known or unknown documents. Invention embodiments may choose any number of similarity operations, deploying one or more similarity metrics, scores, or even ensembles of multiple similarity metrics and scores to facilitate the document based query and information retrieval.

Certain embodiments of the invention may include one or more technical advantages. A technical advantage of the embodiments disclosed includes a Web Based Document Query and Information Retrieval System capable of rapidly returning highly similar documents when provided a document based search by a search initiator. Another technical advantage includes document based search results provided to the search initiator which may include not only a measure of similarity between the document based query and each document contained within the search result, but also a matched terms collection containing each matched term and relevant similarity score details for each matched term occurring between a document based query and each document contained within the search result. In certain embodiments, rapidly understanding why two documents are similar may be more important than just the fact that the two documents are, in fact, highly similar.

Yet another technical advantage includes document processing steps which organizes document term data in a manner conducive to rapid document based query and information retrieval. For example, storing pre-processed term collections and, in some embodiments, including pre-calculated document corpora statistics such as inverse document frequency allows rapid retrieval and similarity calculations between documents. Furthermore, document specific term data collections organized by document keys and possibly document sub-keys may be accessed directly from a file server in certain embodiments to avoid the expense and processing overhead associated with a database layer. In addition, document term collections may be transmitted directly to client-side applications transferring the processing overhead of matched terms requests and similarity calculations to the local web client when preferable. However, the invention displays technical advantages as well by allowing these same transactions to be processed on the server-side when needed.

Other technical advantages include document finger printing processes which ensure that similarity pre-processing operations are minimized by selecting only the documents which are most likely to exhibit higher levels of similarity during nearest neighbor identification. Document fingerprints also provide technical advantages during unknown document searches by limiting the total number of documents compared for similarity in certain embodiments. Maintaining pre-processed document neighbors also provides technical advantages allowing for the rapid retrieval of search results when the system is provided known document keys for document based search and information retrieval.

Certain embodiments may include none, some, or all of the above technical advantages. One or more other technical advantages may be readily apparent to one skilled in the art from the figures, descriptions, and claims included herein.

### BRIEF DESCRIPTION OF THE DRAWINGS

For a more complete understanding of the present invention and its advantages, reference is now made to the following description and the accompanying drawings, in which:

FIG. 1 illustrates a block diagram of a Web Based Document Query and Information Retrieval System;

FIG. 2 illustrates a block diagram of a Document Processing System;

FIG. 3 illustrates a block diagram of a Document Similarity Pre-Processing System;

FIG. 4 illustrates a block diagram of a Document Fingerprinting System;

FIG. 5 illustrates a block diagram of a Known Document Neighbors Request;

FIG. 6 illustrates a block diagram of a Known Document Terms Request;

FIG. 7 illustrates a block diagram of a Known Document Terms Request and Match;

FIG. 8 illustrates a block diagram of a Known Document Terms Match Request (Server and Client);

FIG. 9 illustrates a block diagram of a Known Document Content Request; and

FIG. 10 illustrates a block diagram of a Unknown Document Terms Request and Match.

### DETAILED DESCRIPTION

The following detailed description includes exemplary embodiments of the invention disclosed and reference is made to the accompanying figures that form a part hereof. The figures here are shown to illustrate specific embodiments in which the invention may be practiced. Please understand that other embodiments will be utilized which may include structural changes and modifications made without departing from the scope of the present invention.

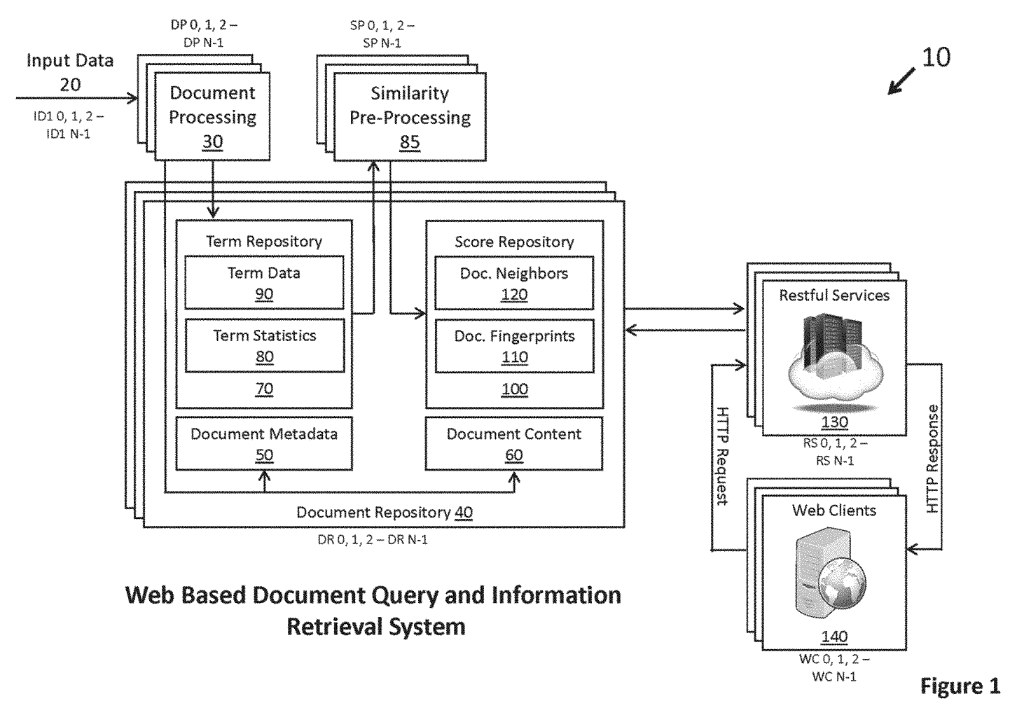

FIG. 1, a Web Based Document Query and Information Retrieval System, is indicated generally by reference 10. The Web Based Document Query and Information Retrieval System 10 illustrates a hardware and operating environment in which this invention's embodiments may be practiced. The following description of FIG. 1 provides a brief and more general description of the computing environment and hardware suitable for this invention's implementation.

While not required, embodiments of this invention are described in the context of program instructions which are executed by a computer. This may include program modules executed on a personal computer, server, mainframe, or other suitable computing device. Program modules may include objects, data structures, libraries, packages, or other components necessary to perform computing tasks, support abstract data types, or any other number of functions required for the given computing task at hand.

Individuals skilled in the art will appreciate that embodiments of this invention may be practiced using other computer, system, hardware, and network configurations, including hand-held devices, multiprocessor systems, embedded systems, programmable electronics, personal computers, laptops, minicomputers, mainframe computers, and other computing devices. System 10 embodiments might also be practiced in a distributed computing and/or web based cloud computing environment where remote processing tasks are performed on devices and systems located in any number of geographic locations linked through a communications network.

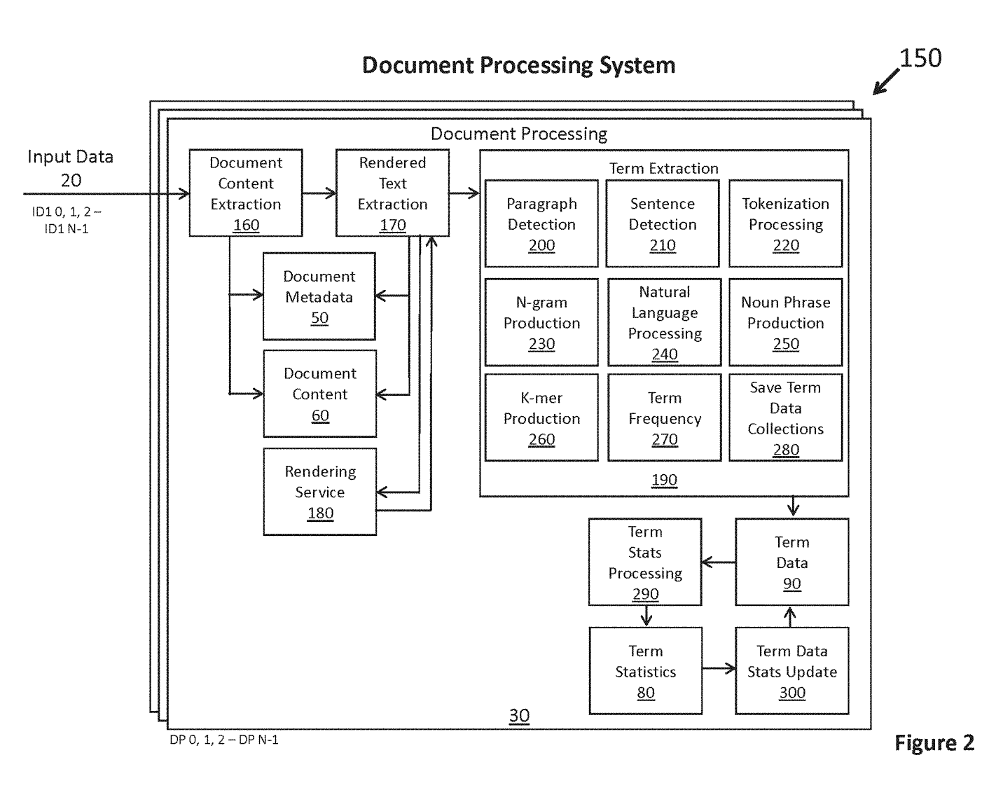

The system 10 includes one or more Document Processing 30 system instances operable to processing one or more sets of Input Data 20. For convenience, any number of individual sets of input data are indicated generally by reference ID1 0,1,2-ID1 N-1. Input Data 20 may comprise any type of digital data conducive to content extraction in the form of text data, including all text characters supported by ASCII, Unicode, EBCDIC, UTF-8, UTF-16, or any other form of character encoding in which text data may exist. Likewise, Input Data 20 documents may include any form of text and or digital content. Certain embodiments for example, may process individual ID1 0,1,2-ID1 N-1 input dataset instances including web pages, news articles, programs, spreadsheets, database tables, patent documents, business documents or any other digital content which a search initiator might conceive a desire to use for the purposes of document based query and information retrieval. The Document Processing 30 system is fully illustrated in FIG. 2 and described in detail within the sections of the detailed description referencing FIG. 2.

Now referring to FIG. 1, multiple individual instances of the Document Processing 30 system are referenced by DP 0, 1, 2-IDP N-1. In some System 10 embodiments, a plurality of Document Processing 30 system instances may be used to receive Input Data 20 instances ID1 0,1,2-ID1 N-1. Likewise, Document Processing 30 system instances DP 0, 1, 2-DP N-1 may execute concurrently as multiple processes, as a single processing instance operating on multiple processing cores in parallel, or any combination of these two. Furthermore, Document Processing system instances DP 0, 1, 2-DP N-1 may execute or operate on multiple computing devices in any number of processing configurations suitable to meet the performance, redundancy, or scalability needs of a particular invention embodiment.

Upon receiving input data instances ID1 0,1,2-ID1 N-1 one or more Document Processing 30 system instances extract displayed text from each piece of digital content received. The Document Processing 30 system typically includes processing steps which populate portions of one or more Document Repository 40 data collections DR 0, 1, 2-DR N-1, including Document Metadata 50, Document Content 60, and Term Repository 70, including Term Statistics 80 and Term Data 90.

In certain invention embodiments, Document Repository 40 data structures may be maintained within one or more relational database management systems, NOSQL database systems, in-memory database systems, or a collection of hash tables or other data structures common to one skilled in the art. In yet another embodiment, one or more file servers supported by a disk drive or solid state storage media, network attached storage, direct attached storage, storage area networks, or any combination thereof may be used to support portions of Document Repository 40.

In one embodiment supporting the US patent corpora, a file server may maintain folders referenced by a known document key, typically a patent number, which contains data collections and entries for Document Content 60, and Term Repository 70, including Term Statistics 80 and Term Data 90. In this embodiment, patent text, extracted term data collections, and term statistics may be directly accessed from a plurality of files maintained on the file server simply by resolving the correct file server path using an appropriate document key and file name for each required repository file.

The Document Repository 40 may also comprise a Score Repository 100 which may include Document Neighbors 120 and Document Fingerprints 110 data structures. The Score Repository 100 is typically populated and updated by one or more Similarity Pre-processing 85 instances SP 0, 1, 2-SP N-1 which may execute concurrently as multiple processes, as a single processing instance operating on multiple processing cores in parallel, or any combination of these two. Furthermore, Similarity Pre-processing 85 system instances SP 0, 1, 2-SP N-1 may execute or operate on multiple computing devices in any number of processing configurations suitable to meet the performance, redundancy, or scalability needs of a particular invention embodiment.

Similarity Pre-processing 85 instances receive unprocessed input from Term Repository 70's Term Data 90 collections processing each unique term entry consistent with Similarity Pre-processing 85 processing requirements. Similarity Pre-processing 85 instances generate a document sketch using each Term Data 90 collection and placing document sketches in the Document Fingerprints 110 data structure. Certain embodiments may include an optional document banding processing step adding a plurality of band values to each document sketch.

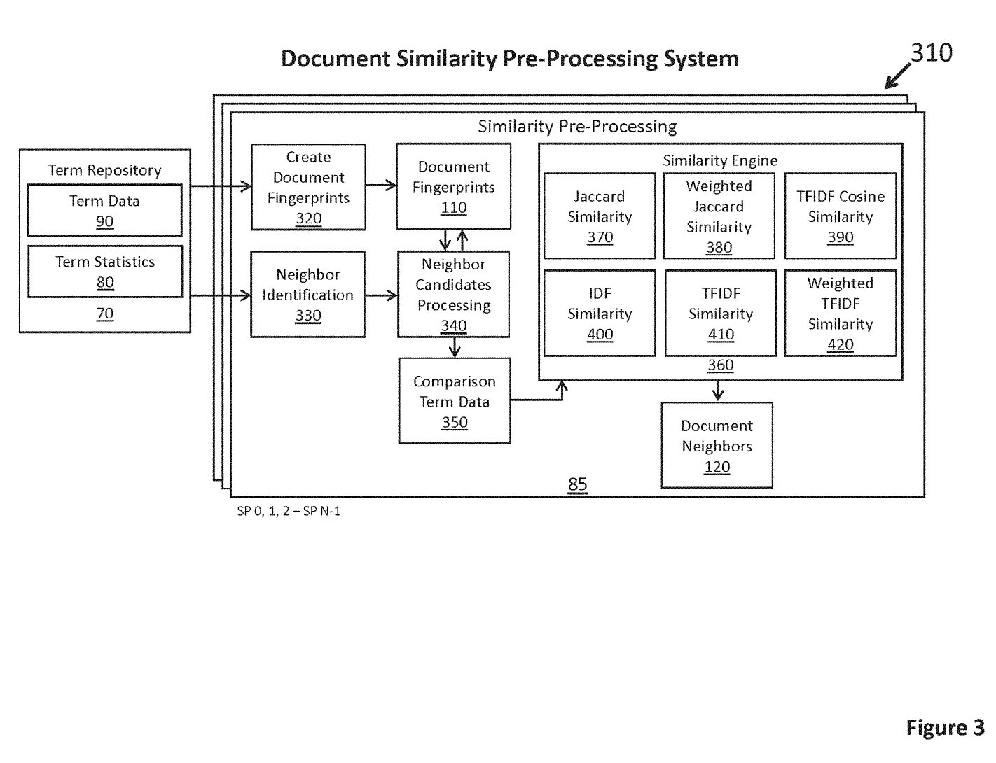

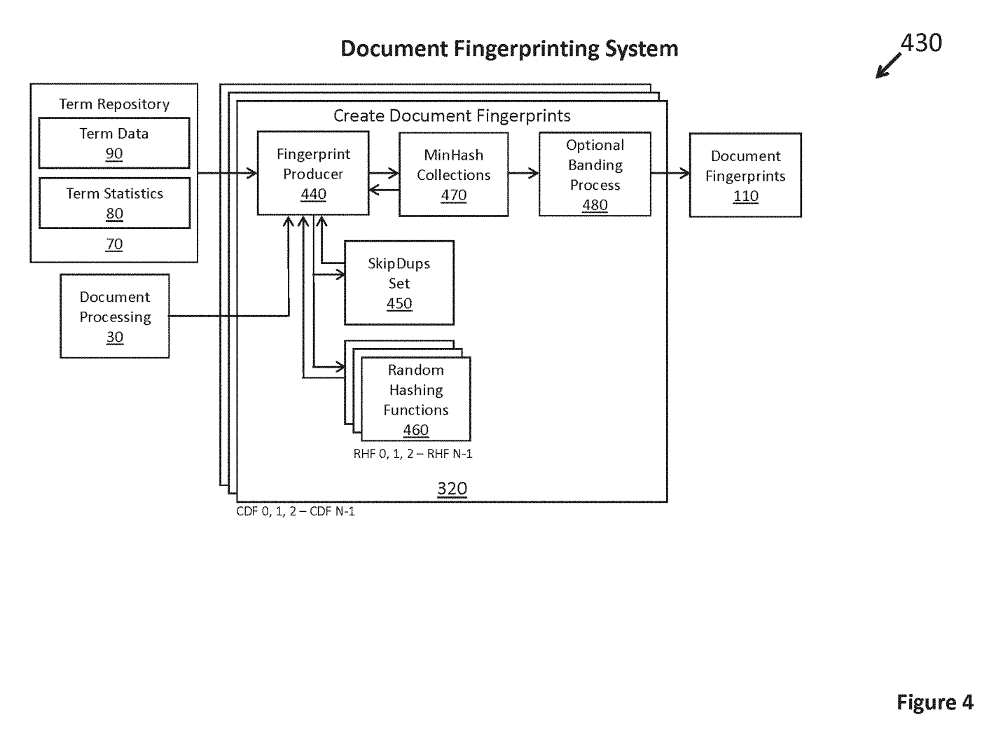

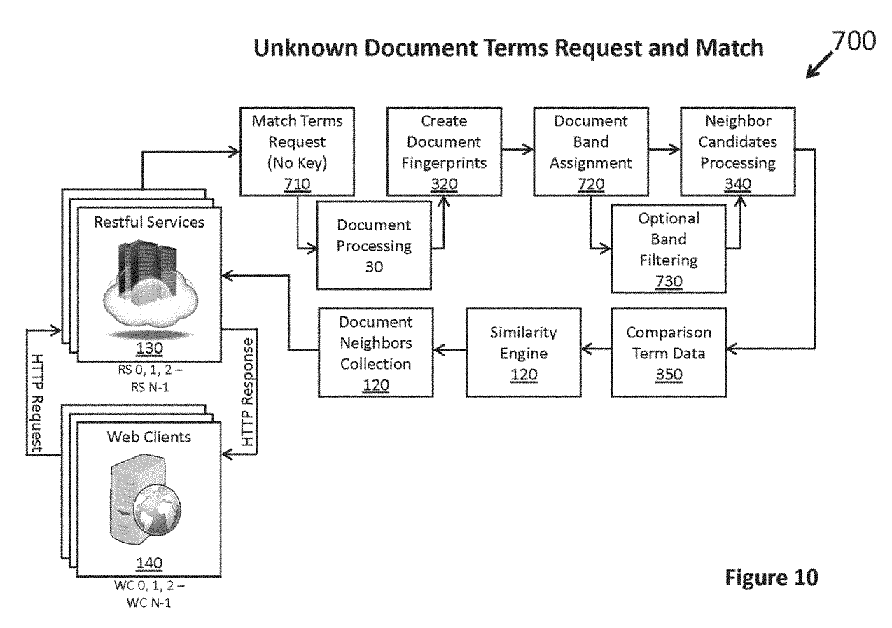

Preferred embodiments of the Document Fingerprints 110 data structure are used for the purposes of dimensionality reduction during nearest neighbor searches. This processing is referenced in FIG. 3's Create Document Fingerprints 320 process and explained in great detail within the FIG. 4 Document Fingerprinting System 430. Such searches may occur during various stages within the Web Based Document Query and Information Retrieval System 10. In one example embodiment, dimensionality reduction via band values is used to exponentially reduce the total number of similarity comparisons while populating the Document Fingerprints 110 data structure. In yet another example, the FIG. 10 Unknown Document Terms Request and Match 700 generates an unknown document sketch to exponentially reduce the number of similarity comparisons required to perform unknown document based search and information retrieval operations.

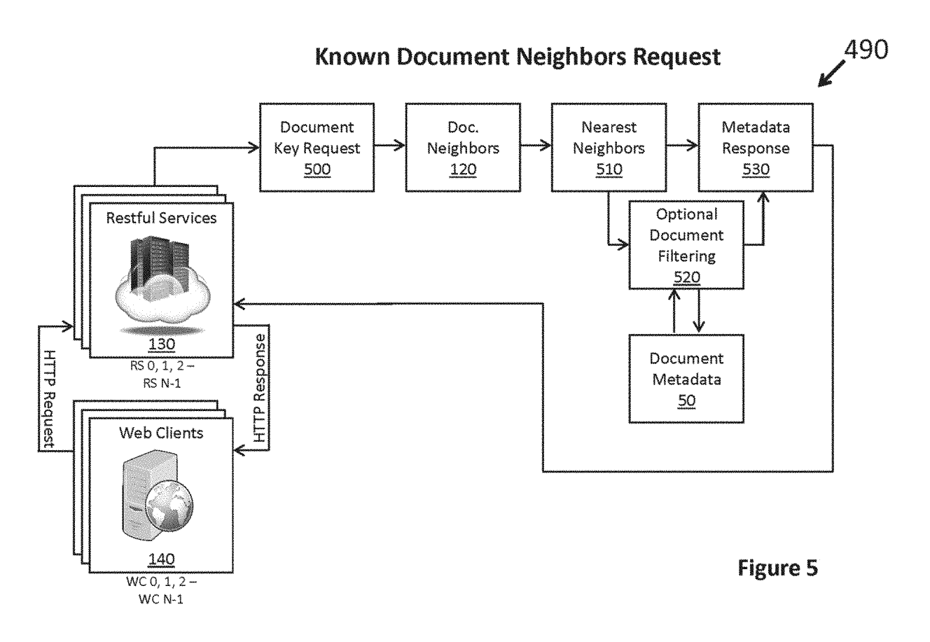

Each Term Data 90 collection processed during Similarity Pre-processing 85 creates an entry within the Document Neighbors 110 repository. The Document Neighbors 110 repository contains a document key entry for each known document within the system which includes the top n most similar document references collection as the value for each entry. The Document Neighbors 110 data structure rapidly services requests for both known and unknown document keys and document sketches. In some embodiments, known document keys are provided as illustrated in the FIG. 5 Known Document Neighbors Request 490. During such a transaction, the similar document references collection is directly accessed via the known document key rapidly providing access to search result candidates for the known document key provided. In other embodiments, optional document sketch band values within the Document Neighbors 110 data structure are matched to one or more bands within a known or unknown document sketch to dramatically reduce the number of similarity comparisons to identify document candidates for similarity score calculations and eventual nearest neighbor candidates.

In the preferred embodiment, Document Repository 40 is accessible to one or more Restful Service 130 instances RS 0, 1, 2-RS N-1 exposing the six exemplary restful requests illustrated in FIG. 5-FIG. 10 to any number of Web Clients 140 instances WC 0, 1, 2-WC N-1. Restful Services 130 are accessible via the HTTP or HTTPS protocols providing stateless transaction oriented services to a web client, web application or both. In other embodiments, Document Repository 40 may be accessible to one or more computer applications servicing requests to an application user via a local communication network, virtual private network, or simply on a local computing device.

In one System 10 embodiment supporting the US patent corpora, the search initiator selects or uploads a known or unknown patent document via the Web Client 140. In turn, Web Client 140 provides a HTTP request, including the appropriate document key and/or sub keys, to the Restful Services 130 via the appropriate services URL. Restful Services 130 provides an HTTP response which includes content representative of the HTTP request initiated by the Web Client 140 instance.

FIG. 2 refers to an exemplary and detailed illustration of a Document Processing System embodiment generally indicated by reference 150. Multiple individual instances of the FIG. 1 Document Processing 30 and the detailed FIG. 2 Document Processing System 150 are referenced by DP 0, 1, 2-DP N-1. One or more Document Processing System 150 instances may operate within the context of a Web Based Document Query and Information Retrieval System 10 embodiment.

Document Processing System 150 instances typically generate term data collections for each input data instance ID1 0,1,2-ID1 N-1 received, and term data collections are typically partitioned by a known document key within the Term Data 90 data structure. Document Content Extraction 160 has extracts appropriate document content for further downstream processing. In an embodiment supporting the US patent corpora for example, patent text HTML and relevant patent metadata is extracted from the raw patent XML data provide by the USPTO bulk data system during the Document Content Extraction 160 processing step. In addition, individual patent documents may be separated into individual input data instances ID1 0,1,2-ID1 N-1 during the Document Content Extraction 160 processing step. Document Content Extraction 160 populates other patent metadata, images, and text into Document Metadata 50 and Document Content 60.

The Rendered Text Extraction 170 processing step transforms targeted document content into displayed or human readable text. For instance, an embodiment processing web pages may remove HTML tags and other non-relevant data from text prior to further downstream text processing operations using a Rendering Service 180 process.

In a preferred embodiment supporting the US patent corpora, HTML formatted patent text and claims are extracted from the raw XML data contained in a USPTO bulk data file during the Document Content Extraction 160 processing step. Next, Rendered Text Extraction 170 executes one or more “headless” browser instances in-memory during the Rendering Service 180 process to transform the patent's HTML to human readable patent text. The patent specific HTML is saved to disk by Rendered Text Extraction 170 in the Document Content 60 repository, and a headless browser instance is directed to render and transform the HTML file using a file:// URL. Once the browser renders the HTML, the transformed patent text is then saved for further downstream document pre-processing in the Document Content 60 repository.

In other Rendering Service 180 embodiments, patent specific HTML may be passed in memory directly to the headless browser using no file, and only the transformed browser text is saved. While the preferred embodiment may use browser rendering to remove HTML tags and HTML specific entity definitions such as: (&amp, &lt, &gt etc.) from patent specific HTML, other embodiments may simply use regular expressions, lookup tables, html processing packages such as HTML agility pack or any combination of the aforementioned tools or other similar tools to process and convert HTML specific input data to text. Yet other embodiments may receive text documents as input data and require no HTML specific or other specific input data transformation processing at all to extract the document's text.

Term Extraction 190 receives document text as input from the Rendered Text Extraction 170 process and applies any number of term processing techniques to the raw document text received. Terms produced during Term Extraction 190 processing may include extractions of any arrangements or portions of document characters and/or words including Paragraph Detection 200, Sentence Detection 210, Tokenization Processing 220, N-gram Production 230, Natural Language Processing 240, Noun Phrase Production 250, K-mer Production 260 (chunks of overlapping document characters produced using a “sliding window”), or any other arrangement of document characters conceived by the application programmer or data scientist to be used for subsequent document similarity comparison or any aspect of document based query and information retrieval processing.

Individual extractions of any unique arrangements or portions of document characters and/or words during Term Extraction 190 processing are referred to as “Terms” in the context of this invention. The Term Extraction 190 process may use any combination of the aforementioned text processing techniques to generate document terms and document term collections. In a preferred embodiment supporting the US patent corpora, transformed patent text input data is processed by one or more Term Extraction 190 processing instances. Sentence detection is performed on transformed patent text dividing the text into sentences. Patent sentences are stored within the Document Content 60 repository and partitioned by patent and claims specific text. Next, any number of additional term collections are generated including N-gram Production 230 processes which create one or more term collections comprising n-grams of varying lengths. In some embodiments, Natural Language Processing 240 may be performed to tag each sentence's part of speech for the subsequent identification of noun phrases within a Noun Phrase Production 250 process.

Any number of programming languages, libraries, packages, or custom code modules or combination thereof may be used to perform Paragraph Detection 200, Sentence Detection 210, Tokenization Processing 220, N-gram Production 230, Natural Language Processing 240, Noun Phrase Production 250, or K-mer Production 260 such as using NLP.net or Sharp.net within the C# programming language. Yet other embodiments may use the Python programming language in combination with OpenNLP, while other embodiments may include original custom processing methods in any programming language to perform such activities. Furthermore, all models used within Natural Language Processing 240 such as tokenization, sentence boundary detection, part of speech tagging and others may be generated using a common document corpus such as the Brown Corpus or others. However, the preferred embodiment will use custom models within Natural Language Processing 240 which are appropriate for the type of documents being processed. For example, embodiments processing US patents may use a sentence boundary detection model which is specific to sentences contained within US patent documents.

Term Frequency 270 processing tracks and updates the number of times each unique term within a term data collection occurs during Term Extraction 190 processing. After Term Extraction 190 processing is completed for a particular document, each term data collection is saved by the Save Term Data Collections 280 process which may comprise the serialization of term data collection objects to disk within the Term Data 90 repository, inserting Term Data Collections 280 into a relational database table or some other data store. In some embodiments, the Save Term Data Collections 280 processing step operates concurrently with Term Extraction 190 processing updating saving each Term within the appropriate Term Data 90 repository as it is encountered during Term Extraction 190 processing.

In the preferred embodiment, Term Statistics 80 is populated with relevant statistics related to the entire document corpora. The Term Statistics 80 data structure is typically a collection of key-value pairs contained within a database, hash table, NOSQL key-value data store, or data structure which is appropriate to one skilled in the art. Term Statistics 80 data typically comprises corpora level data such as term document frequency (i.e. the number of documents a term appears in), unique term totals, corpora total document counts, and any other summary level statistics relevant to subsequent similarity calculations or required for a particular embodiment's practice. Upon completion of Term Extraction 190 instance processing, each document's one or more term data collections are placed within the Term Data 90 repository and associated with the appropriate document key and/or sub keys. A Term Stats Processing 290 instance processes term data collections updating the appropriate entries within Term Statistics 80 repository.

In accordance with one invention embodiment, Term Stats Processing 290 updates Term Document Frequency entries within the Term Statistics 80 repository for each unique term encountered within each unique document. Other invention embodiments may track and update any number of other summary level statistics within the Term Statistics 80 repository about the document corpora, terms contained within the document corpora, or any other statistics conceived by the application programmer to support document based query and information retrieval.

Some embodiments may maintain multiple separate or partitioned Term Statistics 80 repository data structures. For the purposes of scalability and performance, Term Statistics 80 repository partitions may reside on multiple databases tables or servers for a very large document corpora. However, other embodiments may maintain multiple Term Statistics 80 repository data structures to house multiple Term Document Frequency collections or statistics which are required for a particular document based query and information retrieval process. For example, multiple Term Statistics 80 repository data structures may be used to maintain separate term document frequency collections for both patent text and patent claims specific text in an embodiment supporting the US patent corpora.

Once the Term Statistics 80 repository has been updated, Term Data Stats Update 300 processing may perform additional pre-processing update operations on the term data collections to update unique terms with document corpora specific term level statistics. For example, unique terms within a term documents collection may be updated to include the Inverse Document Frequency IDF or the Term Frequency-inverse Document Frequency TF-IDF which may only be calculated using details about the entire document corpora which are unknown during Term Extraction 190 processing.

FIG. 3 refers to an exec exemplary and detailed illustration of a Document Similarity Pre-Processing System embodiment generally indicated by reference 310. One or more Document Similarity Pre-Processing System 310 instances may operate within the context of a Web Based Document Query and information Retrieval System 10 which are referenced as SP 0, 1, 2-SP N-1. A Document Similarity Pre-Processing System 310 instances are also referenced within FIG. 1 and FIG. 3 as Similarity Pre-Processing 85, SP 0, 1, 2-SP N-1.

The Term Repository 70 provides both Term Statistics 80 and. Term Data 90 data structures as input data for Similarity Pre-Processing 85 instances. The Create Document Fingerprints 320 processing step receives as input document specific term data collections from the Term Data 90 data structure and possibly other data from the Term Statistics 80 repository as necessary. Detailed processing steps for the Create Document Fingerprints 320 process are disclosed within FIG. 4. One or more instances of the Create Document Fingerprints 320 process generate document sketches using one or more document specific term data collections. The document sketches are a form of lossy compression and/or dimensionality reduction which succinctly represents a single document's unique characteristics within a collection of numbers or bits which is considerably smaller than the number of entries within the input term document collation. Completed fingerprints for each document are placed into the Document Fingerprints 110 repository during the Create Document Fingerprints 320 step. In some instances however, retaining a document's sketch may not be required. For example, certain embodiments performing unknown document searches may opt not to store the sketches for each unknown document search.

The Neighbor Identification 330 process receives as input document specific term data collections from the Term Data 90 data structure and possibly other data from the Term Statistics 80 repository as necessary performing Neighbor Candidates Processing 340 steps which utilize document sketches and optional band values within the Document Fingerprints 110 repository to perform rapid location of each known document's nearest neighbors. A document's nearest neighbors collection comprise other document references within the known documents corpora which are considered to be highly similar.

In embodiments which contain smaller total numbers of known documents or required the absolute highest estimates of similarity for document neighbors, the Create Document Fingerprints 320 step and the Document Fingerprints 110 repository might be eliminated altogether. However, embodiments containing very large numbers of known documents or requirements for very rapid searches in or population of Document Neighbors 120, multiple layers of levels of document sketches might exist within each Document Neighbors 120 entry.

In accordance with one embodiment of the invention supporting the US patent corpora, both minhashing and locality sensitive hashing operations are utilized to create each Document Neighbors 120 entry. The minhashing process described in detail within FIG. 4 is used to perform a first dimensionality reduction and locality sensitive hashing is also used to generate one or more band values where similar documents are “hashed into” and will receive a similar band value. These band values are used as a second dimensionality reduction to further reduce complexity during nearest neighbor searches.

When Neighbor Candidates Processing 340 determines which document's pairwise similarity should be calculated only documents with an acceptable level of matching band values are selected for Stage 1 of Neighbor Candidates Processing 340. Next in Stage 2, minhash signatures for documents with sufficient matching band values are compared to approximate each document's pairwise similarity. Finally, the top n most similar document approximations may be selected for the top n most similar document references collection and placed directly in the Document Neighbors 120 repository.

In certain embodiments, Neighbor Candidates Processing 340 may provide each top n most similar document references collection to Comparison Term Data 350 for further processing. In this embodiment, Comparison Term Data 350 retrieves each document reference's term data collection providing them to the Similarity Engine 360 where one or more Jaccard Similarity 370, Weighted Jaccard Similarity 380, TFIDF Cosine Similarity 390, IDF Similarity 400, TFIDF Similarity 410, Weighted TFIDF Similarity 420, or any other similarity metric conceived by one skilled in the art for comparing term document collections for similarity while practicing this invention. Document Neighbors 120 top n most similar document references collections are then updated with the final similarity values determined by Similarity Engine 360 processing. In some embodiments, only similarity approximations are generated from document sketches during similarity pre-processing. It is only during actual match requests when actual similarities are determined by a Restful Service 130 or Web Client 140 processing.

FIG. 4, a Document Fingerprinting System, is indicated generally by reference 430. For convenience, any number of individual instances of a Document Fingerprinting System 430's Create Document Fingerprints 320 process are indicated generally by reference CDF 0, 1, 2-CDF N-1. Create Document Fingerprints 320 processing typically performs dimensionality reduction for the purposes of nearest neighbor search. The Term Repository 70 provides term data collections from the Term Data 90 data structure as input for Create Document Fingerprints 320 processing. In certain instances, such as the Unknown Document Terms Request and Match 700 which is illustrated in FIG. 10, a Document Processing 30 instance may also provide term data collections as input to Create Document Fingerprints 320. Fingerprint Producer 440 includes a Skip Dups Set 450 and a plurality of Random Hashing Functions 460. For convenience, individual hashing function instances are referenced by RHF 0, 1, 2-RHF N-1. Fingerprint Producer 440 process performs dimensionality reduction on individual term data collections by passing each term data term within the term data collection through each of the Random Hashing Functions 460 generating a hash value from each hashing function instance RHF 0, 1, 2-RHF N-1.

In one example embodiment supporting the US patent corpora, Random Hashing Functions 460 includes 100 random hashing functions RHF 0, 1, 2-RHF 99. Each term within a term document collection for a single patent application is passed first checked within Skip Dups Set 450 to ensure this has not been previously hashed for the same document. In the preferred embodiment, term document collection's will only contain unique terms and the Skip Dups Set 450 will not be required. Each unique term within the term data collection is passed through the 100 random hashing functions RHF 0, 1, 2-RHF 99 while the Fingerprint Producer 440 maintains only the minimum hash values produced by RHF 0, 1, 2-RHF 99 resulting in a minhash signature containing 100 integers. In the preferred embodiment, multiple term data collections may be processed in parallel on multiple processors and/or computing devices processing multiple term data collections simultaneously. Minhash Collections 470 may be a thread-safe collection capable maintaining multiple minhash signatures for multiple term data collections simultaneously. Some embodiments may use optimal thread-safe, lock free, in-memory data structures for the Minhash Collections 470 while other embodiments may use locking strategies with more common data structures to house Minhash Collections 470.

In certain embodiments, each completed minhash signature is accessed from the Minhash Collections 470 data structure by the Optional Banding Process 480. Additional banding values are added to each completed minhash signature by generating a single hash from each of the minhash values within a particular band to produce a single band value for each band. For example, the minimum hash values generated by RHF 0, 1, 2-RHF 99 may be divided into 5 bands of 20 minhash values each. For the first band, a single hash value is produced using minhash values RHF 0-RHF 19 to produce the value for band 1. The final minhash signature now contains 100 minhash values plus 5 additional banding values for a total of 105 values. Final minhash signatures are placed into he Document Fingerprints 110 repository by the Create Document Fingerprints 320 process.

The exemplary Web Based Document Query and Information Retrieval System 10 illustrated in FIG. 1 supports 6 primary restful requests in the service of web based document queries and information retrieval. Each of these restful requests are provided by one or more Restful Services 130. Typically, one or more Web Clients 140 represent a search initiator performing one or more aspects of web based document queries and information retrieval. Each of the 6 primary restful requests are facilitated via stateless HTTP requests from Web Clients 140 which are provided HTTP responses from the Restful Services 130.

FIG. 5, a Known Document Neighbors Request, is indicated generally by reference 490. The Known Document Neighbors Request 490 begins with a HTTP request generated by a Web Client 140. The Restful Service 130 receives a HTTP request containing Document Key Request 500 including a known document key. In the preferred embodiment supporting the US patent corpora, the known document key may represent a known US patent number and optional sub-key indicating to perform a patent text, claims specific text, or patent full text document based query. The Document Key Request 500 processing retrieves the known document key's top n most similar document references collection from the Document Neighbors 120 repository. Nearest Neighbors 510 currently includes all document references contained within the top n most similar document references collection, but may perform Optional Document Filtering 520 to remove any documents which are not relevant for the search. Optional Document Filtering 520 may utilize additional data provided within the Document Key Request 500 in combination with the Document Metadata 50 to filter and reduce records included in the document key's top n most similar document references collection. Finally a metadata based search result is included in Metadata Response 530 which is provided in the HTTP response generated by Restful Services 130 and transmitted back the search initiator's Web Client 130.

In some embodiments document based query search results may include very limited document metadata such as the document key, a US patent application number in some embodiments for example, the document title, author, inventor, assignee, and a brief selection of the document text. However, other embodiments may return a much more robust document based search result including estimated or actual document similarity scores, pre-fetched document term sets for some or all of the documents within a search result, and other document content such as a pdf or other files containing all or portions the document's text.

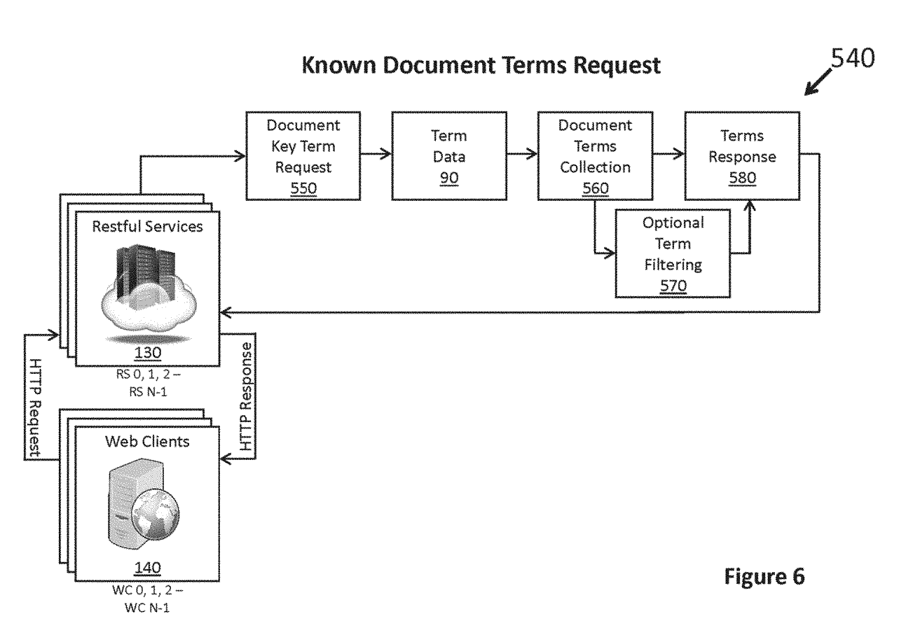

FIG. 6, a Known Document Terms Request, is indicated generally by reference 540. The Known Document Term Request 540 begins with a HTTP request generated by a Web Client 140. The Restful Service 130 receives a HTTP request containing Document Key Term Request 550 including a known document key. In the preferred embodiment supporting the US patent corpora, the known document key may represent a known US patent number and optional sub-key indicating to perform a patent text, claims specific text, or patent full text document based query. The Document Key Term Request 550 processing retrieves the term data collection for the known document key provided from the Term Data 90 repository.

Document Terms Collection 560 currently includes all document term is contained within the document terms collection, but may perform Optional Term Filtering 570 to remove any terms which are not relevant for the request. For example, terms below a certain TFIDF score within the terms collection may be filtered. Optional Term Filtering 570 may utilize additional data provided within the Document Key Term Request 550 in combination with additional data within the term document collection to filter and reduce term records included in the document key's term data collection. Finally the appropriate term data collection is provided in Terms Response 580 which is included in the HTTP response generated by Restful Services 130 and transmitted back the search initiator's Web Client 130.

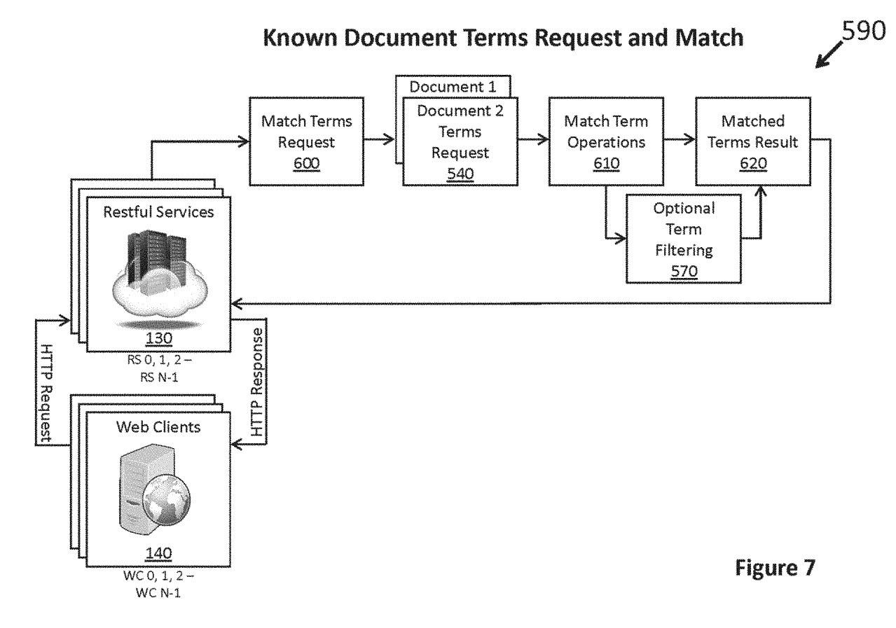

FIG. 7, a Known Document Terms Request and Match request, is indicated generally by reference 590. The Known Document Terms Request and Match 590 begins with a HTTP request generated by a Web Client 140. The Restful Service 130 receives a HTTP request containing Match Terms Request 600 including at least two known document keys. Next, a server-side Document Key Term Request 550 is performed for both each of the requested known document keys. Match Term Operations 610 receives at least two term data collections for at least two known document keys. The term data collections are matched or intersected to obtain all matching terns between the two term document collections. As previously described, certain embodiments may include additional matching operation steps during the Match Term Operations 610 process.

Optional Term Filtering 570 may utilize additional data provided within the Match Terms Request 600 in combination with additional data within the term document collection to filter and reduce term records included in the Match Term Operations 610 resulting matched term data collection. Finally the appropriate term data collection is provided in Matched Terms Result 620 which is included in the HTTP response generated by Restful Services 130 and transmitted back the search initiator's Web Client 130.

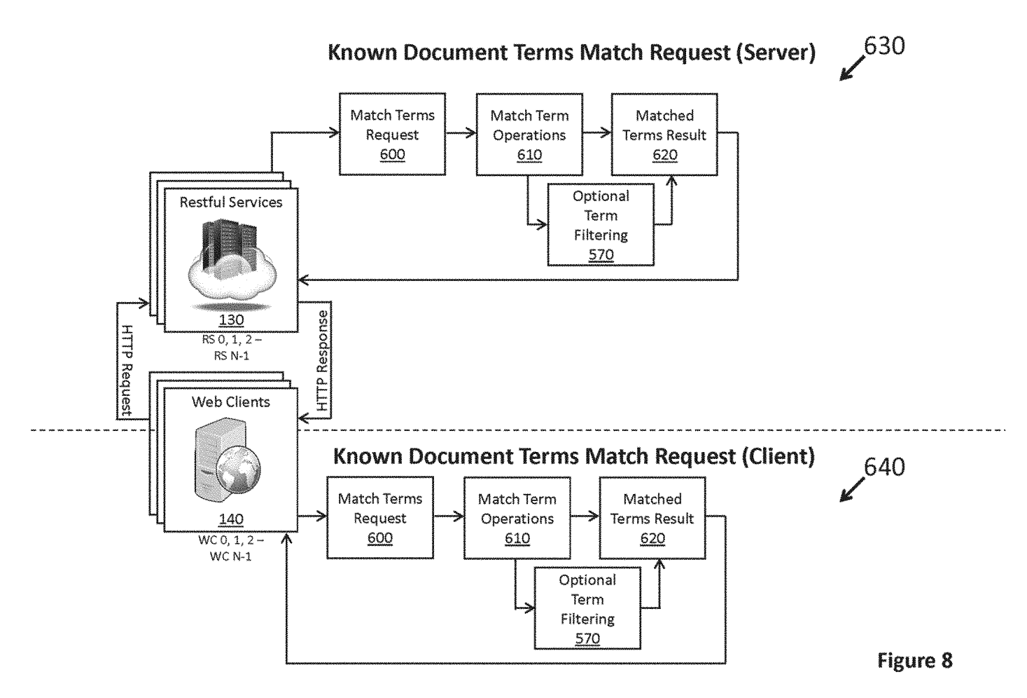

FIG. 8, a Known Document Terms Match Request, is indicated on the server side generally by reference 630 and on the client side generally by reference 640. The Known Document Terms Match Request 630 begins with a HTTP request generated by a Web Client 140. The Restful Service 130 receives a HTTP request containing Match Terms Request 600 including at least two term document collections as input. The Known Document Terms Match Request 640 begins at Web Client 140 with a Match Terms Request 600 including at least two term document collections as input.

In the Known Document Terms Match Request 640 embodiment, the Web Client 140 is assumed to already have at least two term document collections locally residing within the Web Client 140. For example, perhaps one user has reviewed term document collections for two patents of interest and now wants to compare them. The Known Document Terms Match Request 640 presents functionality to perform this match operation on the client side.

Match Term Operations 610 receives at least two term data collections for at least two known document keys. The term data collections are matched or intersected to obtain all matching terms between the two term document collections. As previously described, certain embodiments may include additional matching operation steps during the Match Term Operations 610 process. Optional Term Filtering 570 may utilize additional data provided within the Match Terms Request 600 in combination with additional data within the term document collection to filter and reduce term records included in the Match Term Operations 610 resulting matched term data collection. Finally the appropriate term data collection is provided in Matched Terms Result 620 which is included in the HTTP response generated by Restful Services 130 and transmitted back the search initiator's Web Client 130.

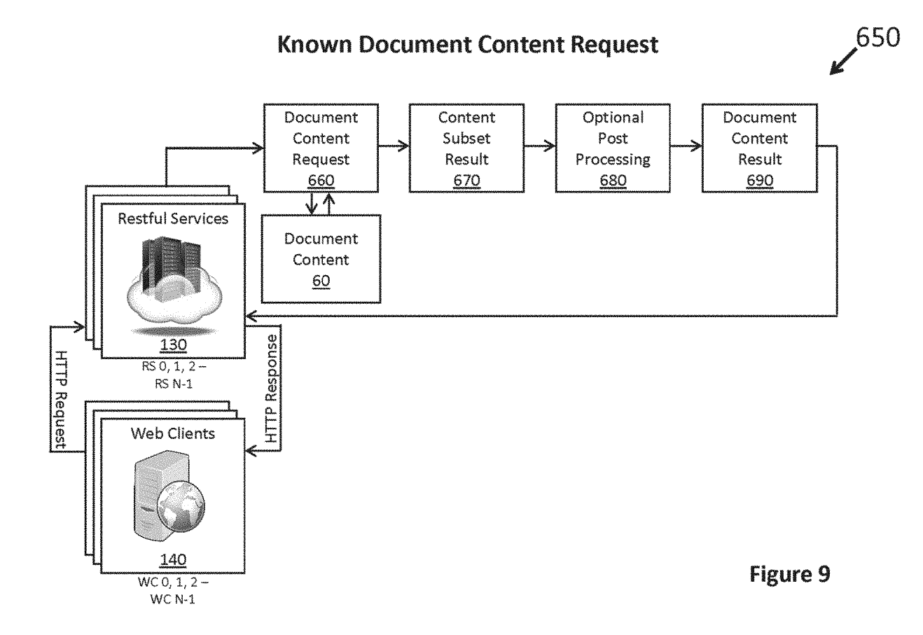

FIG. 9, a Known Document Content Request, is indicated generally by reference 650. The Known Document Content Request 650 begins with a HTTP request generated by a Web Client 140. The Restful Service 130 receives a HTTP request containing Document Content Request 660 including a known document key. In the preferred embodiment supporting the US patent corpora, the known document key may represent a known US patent number and optional sub-key indicating o perform a patent text, claims specific text, or patent full text document based query. The Document Content Request 660 processing retrieves the appropriate Document Content 60 repository file which simply resolves the appropriate file path for the required document content file such as: //US123456/ContentRepository/patentUS123456.pdf.

Once the document content is retrieved, it could be further subset during Content Subset Result 670 processing or post-processed during Optional Post Processing 680 as part of a content processing operations occurring on either the client or server side. In one example embodiment, patent claims text retrieved from the content repository is tagged by a natural language processing engine to extract and provide all noun phrases contained within the claims text. Yet in another embodiment, a patent's pdf formatted document is modified to highlight a set of matching terms provided as input with the content request. In this embodiment, these terms may or may not have originated from the same patent included in the content request. Finally, the Document Content Result 690 is included in the HTTP response generated by Restful Services 130 and transmitted back the search initiator's Web Client 130.

FIG. 10, an Unknown Document Terms Request and Match, is indicated generally by reference 700. The Unknown Document Terms Request and Match 700 begins with a HTTP request generated by a Web Client 140. The Restful Service 130 receives a HTTP request containing Match Terms Request (No Key) 710 including either unknown document text or a unknown document term data collection extracted on the client side. In the case of unknown document text, Document Processing 30 is performed to generate the unknown document term data collection. Next, the Create Document Fingerprints 320 process performs dimensionality reduction including optional Document Band Assignment 720 and Optional Band Filtering 730 as previously described prior to performing Neighbor Candidates Processing 340 to identify the unknown document's top n most similar document references collection.

In certain embodiments, Comparison Term Data 350 processing in combination with Similarity Engine 120 are utilized to determine the exact document similarities for each document within the top n most similar document references collection. However, other embodiments may choose to provide the similarity approximations generated during Neighbor Candidates Processing 340 within top n most similar document references collection. In such embodiments, exact similarity values are only determined when the Web Clients 140 choose specifically to compare two document's term document collections.

In one example embodiment, upon closer review of patents returned with a particular document based query and search result using only similarity approximations, the search initiator decides to compare her document based query specifically to search result item one. At this time Web Client 140 requests a Known Document Terms Match 630 or 640 which obtains the matching terms between both documents and an exact measure of similarity at that time. Finally, after Neighbor Candidates Processing 340 has identified the unknown document's top n most similar document references collection, the Matched Terms Result 620 is included in the HTTP response generated by Restful Services 130 and transmitted back the search initiator's Web Client 130.

The previous descriptions, for the purposes of explanation, have been detailed with reference to specific embodiments of the invention. However, the illustrative details are not intended to be exhaustive or limit the invention in any way to only the details which have been disclosed. A myriad of changes, alterations, transformations, and modifications may be suggested to one skilled in the art, and it is intended that the present invention encompass such changes, alterations, transformations, and modifications as fall within the scope of the appended claims. The embodiments were selected and explained to best embody the principals of the invention and its practical applications, to thereby enable others skilled in the art to best utilize the invention and various embodiments with changes, alterations, transformations, and modifications as are suited to the particular use contemplated.

What is claimed is:

1. A method for identifying documents within a document corpus empirically determined to be similar to a document of a document-based search query and for identifying the empirically determined similarities, the method comprising:
accessing a plurality of related documents in a document corpus;
creating a document fingerprint for each stored document by:
extracting document data from each stored document's content;
making empirical measurements on the extracted document data for each stored document, the empirical measurements representing unique characteristics of each stored document's content;
receiving a document-based search query from a user for identifying one or more documents from the document corpus empirically determined to be similar to the document of the received document-based search query;
determining one or more documents from the document corpus to be empirically similar o the document of the received document-based search query based on exactly matching one or more of the empirical measurements in the document fingerprints of documents in the document corpus with corresponding one or more empirical measurements made for a document fingerprint created for the document of the document-based search query;
providing a document-based search result to the user, the search result comprising documents from e document corpus determined to be similar to the document of the document-based search query based on the exact matching one or more empirical measurements of the document fingerprints; and
identifying to the user the exactly matched one or more empirical measurements and associated extracted data from the document fingerprint of the document of the document-based search query and the document fingerprint of each document comprising the search result determined to be similar.

2. A method in accordance with claim 1, further comprising creating the document fingerprint for the document of the received document-based search query upon receipt of the search query.

3. A method in accordance with claim 1, wherein the document of the received document-based search query is selected from the document corpus by the user.

4. A method in accordance with claim 3, wherein each document in the document corpus comprises a unique document identifier, wherein the received document-based search query comprises receiving one or said unique document identifiers from the user, and wherein providing a document-based search result comprises providing a list of said unique document identifiers corresponding to the documents comprising the document-based search results.

5. A method in accordance with claim 1, wherein the made empirical measurements comprising the document fingerprint for each document include lossy compression and/or dimensionality reduction representing each document's unique characteristics within a collection of numbers or bits.

6. A method in accordance with claim 5, wherein determining the one or more documents from the document corpus to be empirically similar to the document of the received document-based search query further comprising generating a score corresponding to a degree of the empirically determined similarity.

7. A method in accordance with claim 5, wherein the dimensionality reduction comprises performing one or more hashing functions on each document's unique characteristics to generate a corresponding hash value from each of the performed one or more hashing functions.

8. A method in accordance with claim 7, wherein one or more hashing functions comprises MinHashing and/or Locality Sensitive Hashing.

9. A method in accordance with claim 5, wherein the dimensionality reduction comprises one or more processes selected from the group consisting of:
Random Sampling;
Principal Component Analysis;
Kernel Principal Component Analysis;
Linear Discriminant Analysis;
Quadratic Discriminant Analysis;
Generalized Discriminant Analysis;
Spectral Methods for Dimensionality Reduction;
Bit sampling for Hamming distance; and
Random Project Dimensionality Reduction.

10. A method in accordance with claim 1, storing the extracted document data and the empirical measurements for each stored document in a repository.

11. A method in accordance with claim 10, further comprising empirically determining similarities between two or more of the stored documents of the document corpus based on matching one or more of the empirical measurements in the document fingerprint(s) of one or more of the stored documents with corresponding one or more empirical measurements in the document fingerprint(s) for another one or more of the stored documents prior to receiving the search query.

12. A method in accordance with claim 11, further comprising storing document neighbor data regarding the empirically determined similar two or more stored documents and the matched one or more empirical measurements used to determine their similarity.

13. A method in accordance with claim 1, wherein the extracted document data is data regarding one or more selected from the group consisting of:
character(s) occurring in a document;
term(s) occurring in a document;
collection(s) of terms occurring in a document;
metadata of a document;
metadata occurring in a document;
metadata occurring in the document corpus;
metadata occurring in a document with regards to all documents in the document corpus; and
statistics regarding one or more of character(s) occurring in a document, term(s) occurring in a document, collection(s) of terms occurring in a document, metadata of a document; metadata occurring in a document; metadata occurring in the document corpus and metadata occurring in a document with regards to all documents in the document corpus.

14. A method in accordance with claim 1, wherein identifying to the user the exactly matched one or more empirical measurements and associated extracted data further comprises presenting to the user the document of the document-based search query and one or more of each document comprising the search result, each said presented document having visual indicators illustrating one or more of the exactly matched one or more empirical measurements and associated extracted data therein.
